(19) United States
(12) Patent Application Publication
(10) Pub. No.: US 2015/0343542 A1
(43) Pub. Date: Dec. 3, 2015

(54) DEVICE AND METHOD FOR SHARPENING DULLED SAW BLADES

(71) Applicant: Gregory DUNDA, Roanoke, VA (US)

(72) Inventor: Gregory DUNDA, Roanoke, VA (US)

(21) Appl. No.: 14/724,588

(22) Filed: May 28, 2015

Related U.S. Application Data
(60) Provisional application No. 62/004,530, filed on May 29, 2014.

(51) Int. Cl. B23D 63/12; B24D 5/06

(52) U.S. Cl. CPC B23D 63/123; B24D 5/066

(57) ABSTRACT

A sharpening device for cost-effectively sharpening dulled saw blades and a method of making and using the same is provided. The sharpening device may form a tooth-like configuration adapted to rotatably grind and sharpen a saw-teeth configuration into a saw blade.

### CROSS-REFERENCE TO RELATED APPLICATION

This application claims the benefit of priority of U.S. provisional application No. 62/004,530, filed 29 May 2014, the contents of which are herein incorporated by reference.

### BACKGROUND OF THE INVENTION

The present invention relates to improvement in saws and, more particularly, to a device and method for cost-effectively sharpening dulled vibratory and oscillatory saw blades.

Vibratory and oscillatory saw blades tend to wear out quickly and need to be replace often. Currently there is no affordable apparatus or method of sharpening worn out blades, making extended use of such blades a capital intensive proposition.

As can be seen, there is a need for a device and method for cost-effectively sharpening dulled vibratory and oscillatory saw blades.

### SUMMARY OF THE INVENTION

In one aspect of the present invention, a device for defining a saw-teeth configuration into a peripheral edge of a blade includes an arbor extending from a first portion to a second portion; a plurality of grinding discs disposed along the first portion of the arbor; and a plurality of spacers, each spacer disposed along the first portion of the arbor between adjacent grinding discs, forming a tooth-like configuration of grinding discs.

In another aspect of the present invention, a device for defining a saw-teeth configuration into a peripheral edge of a blade includes an arbor extending from a first portion to a second portion; and a cylinder forming a tooth-like configuration along a portion of its periphery, wherein the cylinder is secured along the first portion of the arbor.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use;

FIG. 2 is a perspective detail view of an exemplary embodiment of the present invention, shown in use;

FIG. 3 is a perspective view of an exemplary embodiment of the present invention;

FIG. 4 is a reverse perspective view of an exemplary embodiment of the present invention;

FIG. 5 is a side view of an exemplary embodiment of the present invention;

FIG. 6 is a section view of an exemplary embodiment of the present invention, taken along line 6-6 in FIG. 3;

FIG. 7 is an exploded view of an exemplary embodiment of the present invention, shown in use;

FIG. 8 is a perspective view of an exemplary embodiment of the present invention;

FIG. 9 is a section view of an exemplary embodiment of the present invention, taken along line 9-9 in FIG. 8;

FIG. 10 is a detail section view of an exemplary embodiment of the present invention;

FIG. 11 is a perspective view of an exemplary embodiment of a saw blade in a dulled configuration; and

FIG. 12 is a side view of an exemplary embodiment of the saw blade in a sharpened configuration.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a sharpening device for cost-effectively sharpening dulled saw blades and a method of making and using the same. The sharpening device may form a tooth-like configuration adapted to rotatably grind and sharpen a saw-teeth configuration into a saw blade.

A saw blade 26 of a vibratory or oscillating saw 24 typically provides a thin blade of steel forming a saw-teeth configuration 30 along its peripheral edge 28. From time to time, the saw-teeth configuration 30 becomes worn-down and in need of sharpening.

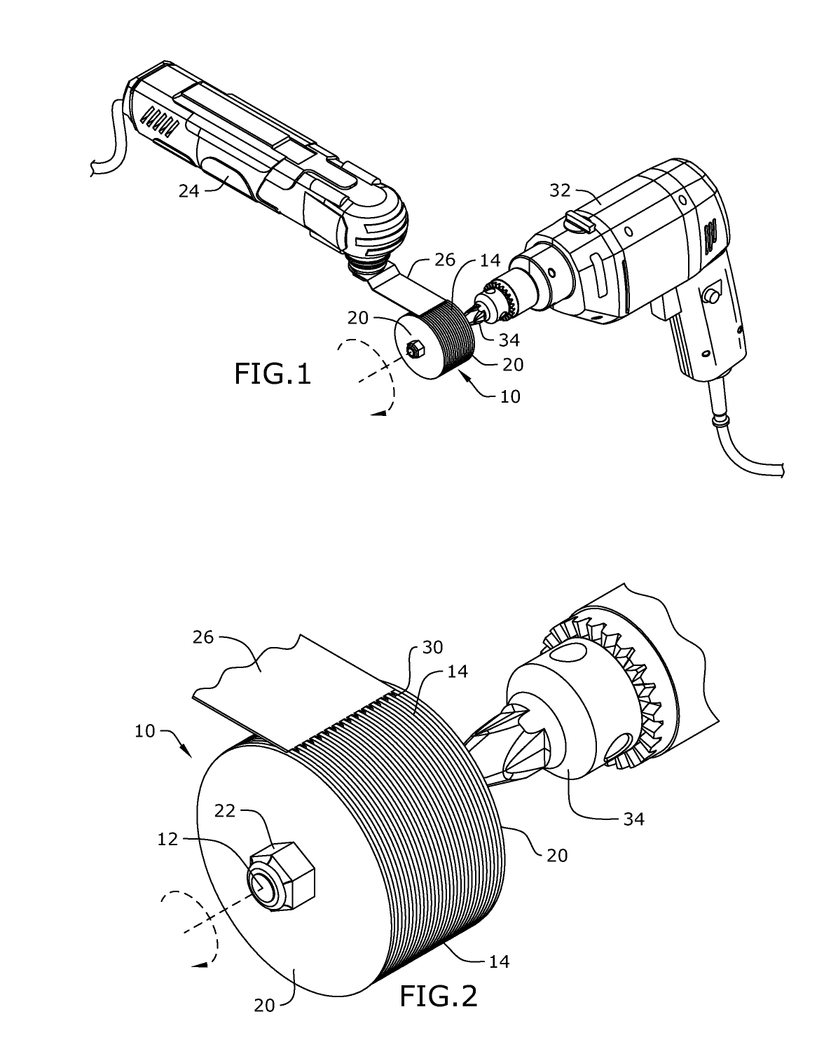

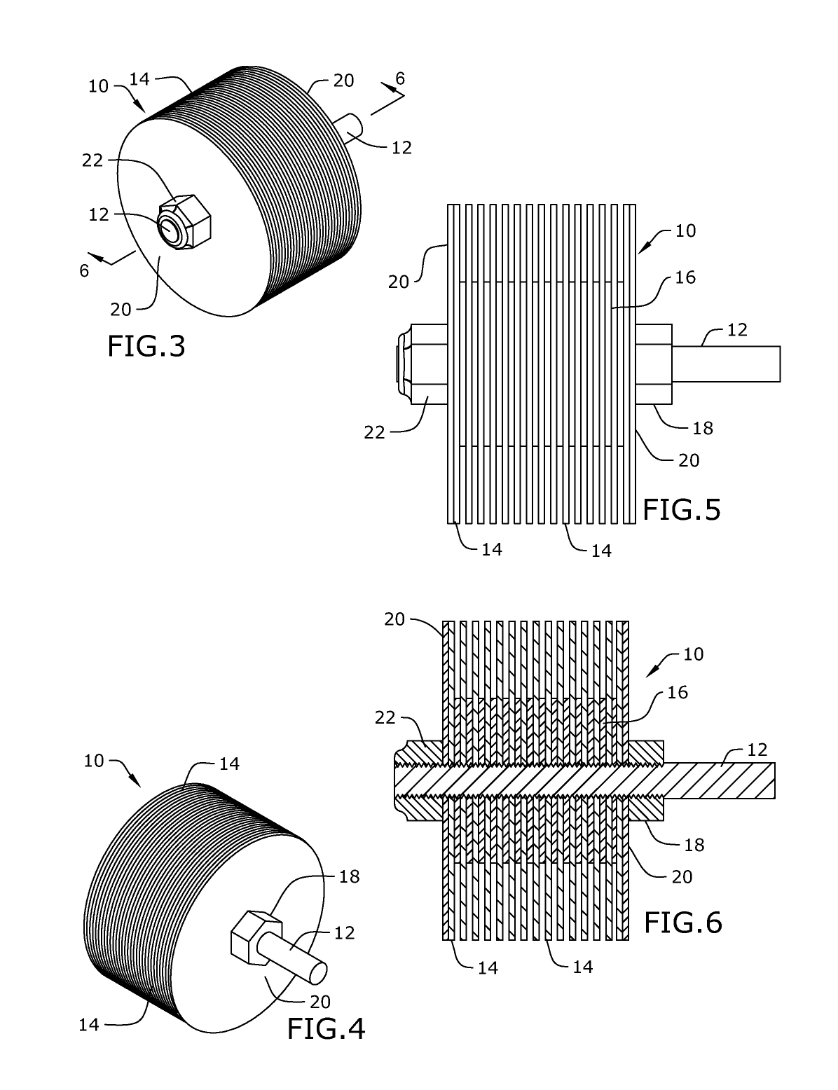

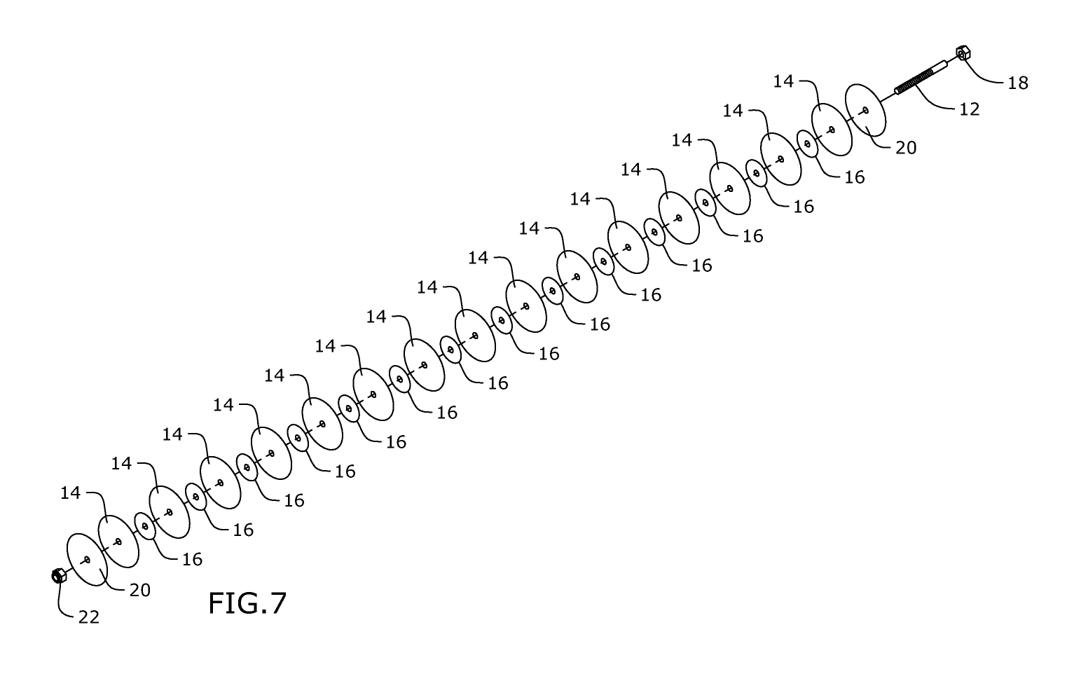

Referring to FIGS. 1 through 7, the present invention may include a sharpening device 10 and a method of making and using the same. The sharpening device 10 may include an arbor 12, a plurality of grinding discs 14 and a plurality of spacers 16. Each spacer 16 and grinding disc 14 may form an arbor hole dimensioned and adapted for snugly receiving the arbor 12 through the plurality thereof. The plurality of grinding discs 14 may be evenly spaced along the arbor 12 by the plurality of spacers 16 disposed between each adjacent grinding disc 14, as illustrated in FIGS. 5 through 7, so as to form a series of sharpening ridges divided by valleys, providing a tooth-like configuration. Each grinding disc 14 may be generally circular so that the tooth-like configuration forms a cylindrical profile.

Each grinding disc 14 may be made of cutting stone, metal or another sufficiently strong material so as to function in accordance with the present invention as described herein. Each spacer 16 may be made of rubber or other material that is sufficiently resilient and durable so as to function in accordance with the present invention as described herein.

A threaded surface may be disposed along a portion of the arbor 12, typically along a threaded portion so as to define a non-threaded portion, as illustrated in FIG. 6. The present invention may include a nut fastener 18, a washer fastener 22, and a pair of protective plates 20. Each protective plate 20 and the fastener 18 and 22 may form an arbor hole dimensioned and adapted to snugly receive the threaded portion of the arbor 12. Each arbor hole may have cooperating threading along its periphery for facilitating a mated engagement with the threaded portion of the arbor 12.

Each protective plate 20 may be disposed so as to bookend one of the two opposing ends of the evenly spaced plurality of grinding discs 14, thereby sandwiching the plurality of discs 14 and spacers 16. Each protective plate 20 may be dimensioned and adapted to protect the plurality of grinding discs 14 from breaking if the sharpening device 10 is banged or dropped. The nut fastener 18 and the washer fastener 22 may be disposed so as to bookend the opposing protective plates 20, securely engaging the plurality of grinding discs 14 to the arbor 12. Thus the pair of threaded fasteners 18 and 22 (or two 22s) may be disposed and secured along the threaded portion of the arbor 12 so as to sandwich the plurality of grinding discs 14.

A method of making the present invention may include the following. First, an individual may thread the nut fastener 18 along the arbor 12 to near the non-threaded portion. Then the individual may thread one protective plate 20 along the threaded portion of the arbor 12 so as to abut the nut fastener 18. Then the individual may alternatively thread one grinding disc 14 and one spacer 16 along the arbor 1, thereby creating the tooth-like configuration. Then the individual may thread the second protective plate 20 followed by the washer fastener 22, so that the protective plate 20 abuts the last grinding disc 14 in the alternative series.

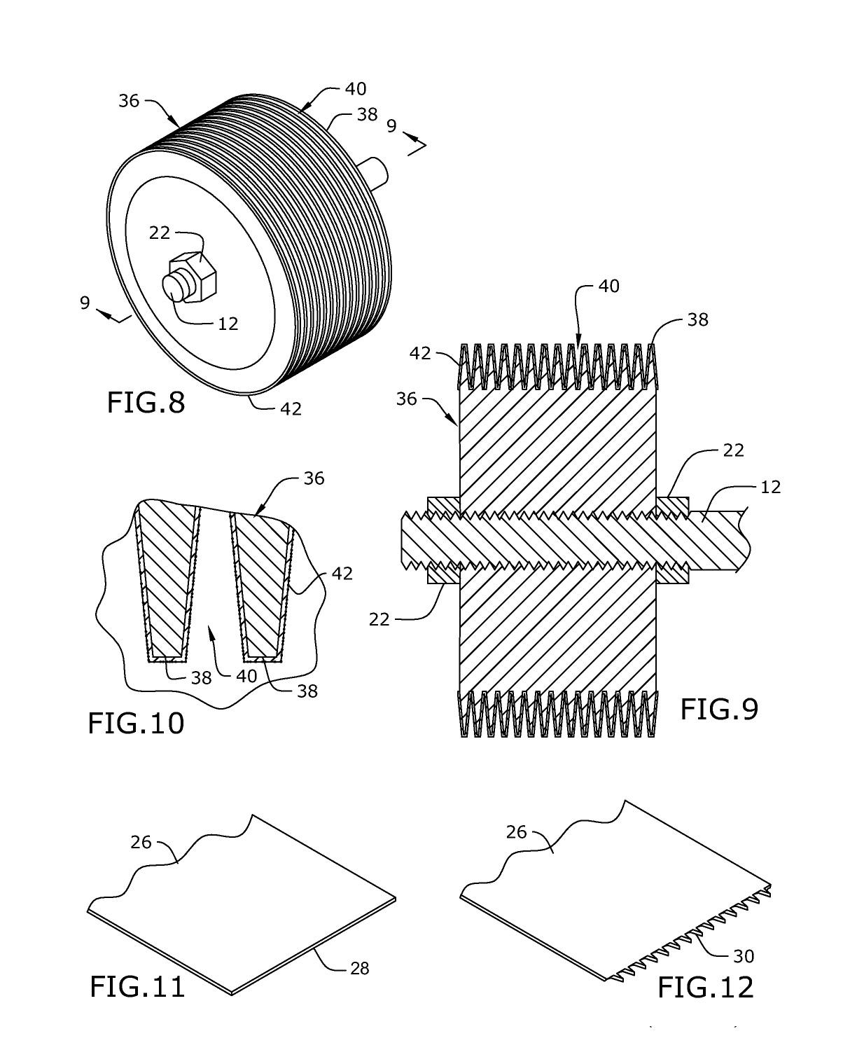

Referring to FIGS. 8 through 10, an alternative method of making the present invention may include the following. The individual secure a cylinder 36 along the threaded portion of the arbor 12, so as to bookend said cylinder 36 between the nut fastener 18 and the washer fastener 22 (or between two washer fasteners 22), as illustrated in FIG. 9. The cylinder 36 may be made of cutting stone, metal or another sufficiently strong material. The cylinder 36 may form an arbor hole, as disclosed above, for such purposes. The cylinder 36 may form a series of alternating ridges 38 and valleys 40 along a portion of its periphery, so as to provide the tooth-like configuration, as illustrated in FIGS. 9 and 10. The tooth-like configuration may be machined into the periphery of the cylinder 36. The tooth-like configuration may be treated with a diamond coating 42 adapted to provide the tooth-like configuration with the capability of cutting metal.

The method of using the present invention may include the following. A user may insert the non-threaded portion of the arbor 12 into a chuck 34 of a power tool 32, including but not limited to hand-held power drills, or otherwise rotatably mount the arbor 12 thereto. The user may engage the peripheral edge 28 of the saw blade 26 against the tooth-like configuration of the sharpening device 10. Alternatively, the user may engage the pre-formed saw-teeth configuration 30 of the saw blade 24 by interlocking it with the tooth-like configuration of the sharpening device 10. Then the user may activate the power tool 32 so as to rotate the sharpening device 10, safely spinning away from the user. The user may hold the saw blade 26 to be sharpened on the rotating tooth-like configuration until either the serrated saw-teeth configuration 30 is sufficiently formed, defined and/or sharpened.

It should be understood, of course, that the foregoing relates to exemplary embodiments of the invention and that modifications may be made without departing from the spirit and scope of the invention as set forth in the following claims.

What is claimed is:

1. A device for defining a saw-teeth configuration into a peripheral edge of a blade, comprising:
an arbor extending from a first portion to a second portion;
a plurality of grinding discs disposed along the first portion of the arbor; and
a plurality of spacers, each spacer disposed along the first portion of the arbor between adjacent grinding discs, forming a tooth-like configuration of grinding discs.

2. The device of claim 1, wherein the first portion comprises a threaded surface.

3. The device of claim 2, further comprising a pair of threaded fasteners disposed and secured along the first portion of the arbor so as to sandwich the plurality of grinding discs.

4. The device of claim 3, further comprising a pair of protective plates, each protective plate sandwiched between a threaded fastener an adjacent grinding disc.

5. The device of claim 4, where the second portion of the arbor is configured to rotatably mount to a hand-held power tool.

6. The device of claim 1, wherein the tooth-like configuration form a cylindrical profile.

7. A device for defining a saw-teeth configuration into a peripheral edge of a blade, comprising:
an arbor extending from a first portion to a second portion; and
a cylinder forming a tooth-like configuration along a portion of its periphery, wherein the cylinder is secured along the first portion of the arbor.

8. The device of claim 7, wherein the first portion comprises a threaded surface.

9. The device of claim 8, further comprising a pair of threaded fasteners disposed and secured along the first portion of the arbor so as to sandwich the cylinder.

10. The device of claim 7, where the second portion of the arbor is configured to rotatably mount to a hand-held power tool.
